(19) United States
(12) Patent Application Publication
(10) Pub. No.: US 2015/0134659 A1
(43) Pub. Date: May 14, 2015

(54) DETERMINING COLLECTIONS CAPABLE OF INCLUDING AN OBJECT PRESENTED BY A SOCIAL NETWORKING SYSTEM

(71) Applicant: Facebook, Inc., Menlo Park, CA (US)

(72) Inventors: Kyle Philip Meyer, San Francisco, CA (US); Rose Bihui Yao, San Francisco, CA (US); Matthew Vincent Sain, San Francisco, CA (US); Christopher Alexander Gist, Seattle, WA (US)

(73) Assignee: Facebook, Inc., Menlo Park, CA (US)

(21) Appl. No.: 14/078,459

(22) Filed: Nov. 12, 2013

(51) Int. Cl. G06F 17/30

(52) U.S. Cl. CPC G06F 17/30598
USPC 707/737

(57) ABSTRACT

A social networking system allows users to create collections including objects associated with products, services, games, videos, books or other similar items. An object is associated with a type and one or more actions are associated with the type to identify actions capable of being performed on the object. When an object is presented to a user, the type of the object is compared to types of objects capable of being included in a collection. If the type of the object is capable of being included in a collection, one or more collections associated with actions associated with the type of the object are identified. Information describing the identified collections is generated and presented to the user. By selecting information identifying a collection, the user includes the object in the collection corresponding to the selected information.

### BACKGROUND

This invention relates generally to social networking systems, and in particular to creating collections of objects maintained by a social networking system.

A social networking system allows its users to connect to and communicate with other social network users. Users create profiles maintained by a social networking system that include information about the users, such as interests and demographic information. The users may be individuals or entities such as corporations or charities. The increasing popularity of social networking systems and the significant amount of user-specific information maintained by social networking systems make a social networking system an ideal forum for users to express themselves and share their interests through content maintained by the social networking system. A significant amount of content maintained by social networking systems is associated with consumer products, so a social networking system also provides a forum for users to become aware of products or to facilitate discussions about products.

Conventionally, a social networking system allows users to organize content items presented by the social networking system into one or more collections associated with user profiles corresponding to the users. For example, a user may generate various collections including content items associated with various products or generate collections including content items relating to a particular theme, such as hobbies, animals, etc. However, users of conventional social networking systems are limited to manually configuring the collections and manually identifying content items included in the collections. This is time-consuming and prevents collections from being standardized across different users.

### SUMMARY

A social networking system allows a user to generate one or more collections, each including one or more objects. To simplify inclusion of an object in a collection, a type is associated with each object maintained by the social networking system. One or more actions are associated with a type to indicate actions capable of being performed on an object having the type. Additionally, one or more actions are associated with a collection or with a category of collection. When an object is selected by the social networking system for presentation to the user, the type of the object is determined and compared to types of objects capable of being included in a collection. If the type of the object indicates that the object is capable of being included in a collection, actions associated with the type of the object are identified and collections or categories of collections associated with the actions are determined. Information identifying the determined collections or determined categories of collections is generated and communicated to a client device for presentation to the user. The information identifying the determined collections or determined categories of collections may be presented in conjunction with the object.

If the user selects information identifying a determined collection or a determined category of collection, the object is included in a collection corresponding to the selected information. For example an object identifier associated with the object is associated with a collection identifier associated with a selected collection. In some embodiments, a content item is generated when the object is included in a collection. For example, a story identifying the user, the object, and the collection is generated and presented to additional users connected to the user.

### BRIEF DESCRIPTION OF THE DRAWINGS

FIG. 1 is a high level block diagram illustrating a system environment according to one embodiment.

FIG. 2 is a flow chart of a method for identifying a collectable object and generating a collection interface according to an embodiment.

FIG. 3 is an example of a collection interface according to one embodiment.

FIG. 4A is an example of an alternative collection interface according to one embodiment.

FIG. 4B is an example of a story describing that an object was added to a collection according to one embodiment.

The figures depict various embodiments for purposes of illustration only. One skilled in the art will readily recognize from the following discussion that alternative embodiments of the structures and methods illustrated herein may be employed without departing from the principles of the invention described herein.

### DETAILED DESCRIPTION

### Overview

A social networking system allows users to create collections including objects maintained by the social networking system that represent products, services, games, videos, books or other similar items. Each object maintained by the social networking system is associated with an object type, a unique object identifier and data describing the object (e.g., images, description, price, colors, availability, etc.). One or more actions are associated with an object type to indicate actions that users may perform on an object having the object type. The social networking system may generate an object. Alternatively, an entity external to the social networking system, such as a retailer, may provide information to the social networking system to generate an object to be maintained by the social networking system.

A collection maintained by the social networking system is associated with a collection category that is associated with a combination of an object type and an action type. Consequently, an object is added to a collection based on an object type associated with the object and an action type selected by a user. When an object associated with a type that is capable of being included in a collection, a “collectable object,” is presented to a user, a collection interface identifying one or more collections associated with an object type of the object is presented to the user along with the object. Different collections presented in the collection interface are associated with the object type of the object and different actions capable of being performed on the object. Hence, the collections capable of including the object are determined based on the object type and its associated actions, allowing the user to more easily include the object tin a collection. For example, the user selects a collection from the collection interface to include the object in the selected collection.

### System Architecture

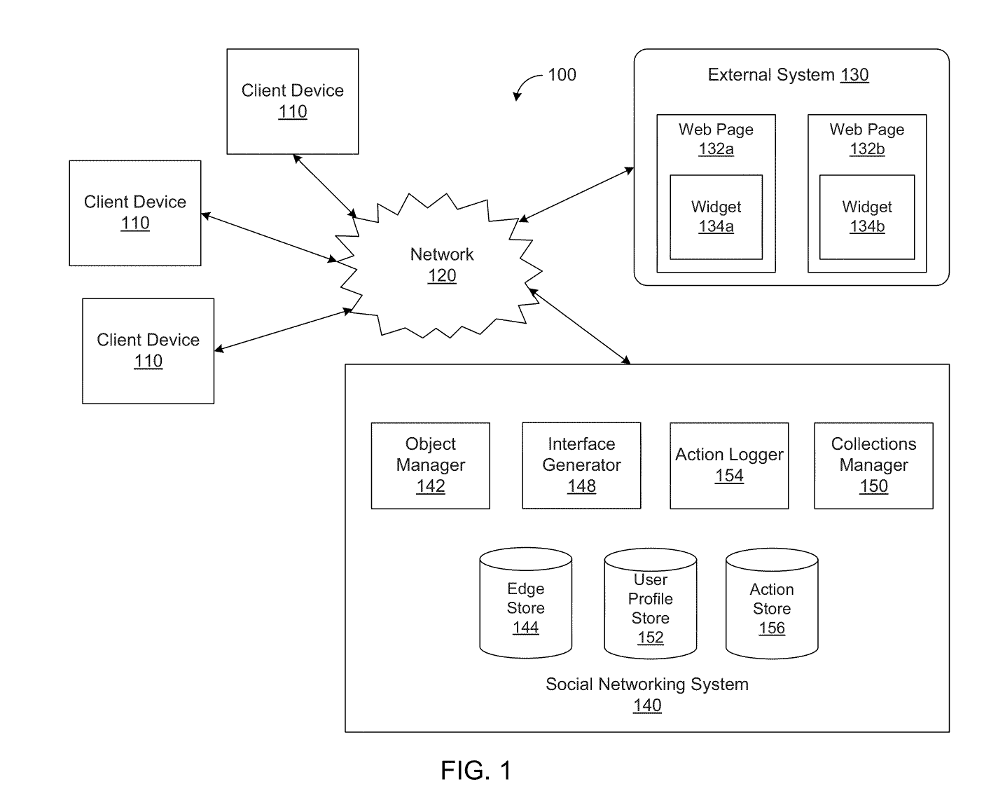

FIG. 1 is a block diagram illustrating a system environment 100 according to one embodiment. The system environment 100 comprises one or more client devices 110, a network 120, an external system 130 and a social networking system 140. In alternative configurations, different and/or additional components may be included in the system environment 100. Additionally, the embodiments described herein may be adapted to online systems that are not social networks.

The client devices 110 are one or more computing devices capable of receiving input as well as transmitting and/or receiving data via the network 120. In one embodiment, a client device 110 is a conventional computer system, such as a desktop or a laptop computer. In another embodiment, a client device 110 may be a device having computer functionality, such as a personal digital assistant (PDA), a tablet computer, a mobile telephone, a smartphone or a similar device. A client device 110 is configured to communicate via the network 120. In one embodiment, a client device 110 executes an application allowing a user of the client device 110 to interact with the social networking system 140. For example, a client device 110 executes a browser application to enable interaction between the client device 110 and the social networking system 140 via the network 120. In another embodiment, a client device 110 interacts with the social networking system 140 through an application programming interface (API) running on a native operating system of the client device 110, such as IOS® or ANDROID™.

The client devices 110 are configured to communicate information via the network 120, which may comprise any combination of local area and/or wide area networks, using both wired and wireless communication systems. In one embodiment, the network 120 uses standard communications technologies and/or protocols. In one embodiment, the network 120 uses standard communications technologies and/or protocols. For example, the network 120 includes communication links using technologies such as Ethernet, 802.11, worldwide interoperability for microwave access (WiMAX), 3G, 4G, code division multiple access (CDMA), digital subscriber line (DSL), etc. Examples of networking protocols used for communicating via the network 120 include multiprotocol label switching (MPLS), transmission control protocol/Internet protocol (TCP/IP), hypertext transport protocol (HTTP), simple mail transfer protocol (SMTP), and file transfer protocol (FTP). Data exchanged over the network 120 may be represented using any suitable format, such as hypertext markup language (HTML) or extensible markup language (XML). In some embodiments, all or some of the communication links of the network 120 may be encrypted using any suitable technique or techniques.

The external system 130 provides content to client devices 110 via the network 120. For example, the external system 130 provides web pages 132a and 132b (collectively, web pages 132) to the client devices 110 using the network 120. Additionally, the external system 130 may communicate content or other data to the social networking system 140 via the network 120. The external system 130 may be separate and independent from the social networking system 140. For example, the external system 130 is associated with a first domain while the social network 140 is associated with a separate social networking domain. The web pages 132 comprise markup language documents including content and instructions specifying formatting or presentation of the content. In one embodiment, web pages 132a, 132b include widgets 134a, 134b comprising instructions that, when executed, retrieve information from the social networking system 140 or communicate information to the social networking system 140, as described in greater detail below. For example, if a user accesses a link embedded within the web page 132a to play a song, the widget 134a communicates information to the social networking system 140 identifying the user and the song played.

The social networking system 140 includes information describing various users as well as information describing connections between users and other users and connections between users. Additionally, the social networking system 140 includes objects that each represents various types of content, and information describing connections between users and objects as well as connections between objects and other objects. The social networking system 140 also stores information describing actions performed by its users. In one embodiment, the social networking system 140 includes an object manager 142, an edge store 144, a user profile store 152, an action logger 154, an action store 156, an interface generator 148 and a collections manager 150. In other embodiments, the social networking system 140 may include additional, fewer, or different components. Conventional components such as network interfaces, security functions, load balancers, failover servers, management and network operations consoles, and the like are not shown so as to not obscure the details of the system architecture.

The object manager 142 stores objects that each represents various types of content. Examples of content represented by an object include a page post, a status update, a photograph, a video, a link, a shared content item, a gaming application achievement, a check-in event at a local business, a brand page, or any other type of content. An object is associated with an object type and a unique object identifier. Social networking system users may create objects stored by the object manager 142, such as status updates, photos tagged by users to be associated with other objects in the social networking system, events, groups or applications. In some embodiments, objects are received from the external system 130 or from a third-party applications separate from the social networking system 140. Social networking system users may perform different actions on an object. As further described below, the actions capable of being performed on an object may be determined based on a type associated with the object.

Information describing an object (e.g., images, description, price, colors, availability, etc.), as well as information identifying a user associated with an object is stored in the object manager 142. Objects included in the object manager 142 may be created by users interacting with the social networking system 140 or may be created based on information received from an external system 130 by the social networking system 140. Generating objects based on information received from an external system 130 allows the external system to customize the content associated with the external system 130 presented by the social networking system 140. The object manager 142 also associates a type with an object based on information included in the object manager identifying types associated with objects maintained or stored by the object manager 142. One or more actions are associated with a type of object to specify actions capable of being performed on an object having the type. The object manager stores information associating actions with various types of objects. For example, a generated object having a type of “user” is associated with actions for establishing a connection to the object, sending a message to the object, blocking communication received from the object, or other suitable actions. As another example, actions capable of being performed on an object having a type of “song” include listening to the object, expressing a preference for the object, sharing the object with another user, or other suitable actions. Actions associated with a type of object may be selected from a set of actions associated with the social networking system 140.

To create an object stored by the object manager 142, an external system 130 identifies one or more properties associated with the object and provides values for the one or more properties to the social networking system for storage in the object manager 142. The external system 130 may also specify a type associated with an object created by the external system 130, allowing customization of content associated with the external system 130 provided by the social networking system 140. Additionally, an external system 130 may provide information describing actions capable of being performed on objects created by the external system. This allows the external system 130 to further customize interaction with objects created by the external system 130 by augmenting actions capable of being performed by the social networking system 140 with customized actions specified by the external system 130. To generate an action, the external system 130 provides one or more properties of the action to the object manager 142, which stores the properties along with an identifier of the action. For example, an external system 130 generates an action for an object provided by the external system 130 by specifying properties identifying a location associated with the action, a user associated with the action, a duration the action was performed, or other suitable parameters. The object manager 142 associates an action with a type of object to indicate the actions capable of being performed on an object having the type.

In one embodiment, actions specified by an external system 130 are associated with types of objects specified by the external system 130. Alternatively, actions specified by an external system 130 may be associated with types of objects generated by the external system 130 and generated via interaction with the social networking system 140. Similarly, actions associated with types of objects generated by the social networking system 130 may also be associated with types of objects generated by an external system 140. For example, an administrator of the social networking system 140 limits association of a “listen” action specified by an external system 130 to types of objects created by the external system 130. Alternatively, an action specified by an external system 130 may be associated with any object maintained by the object manager 142. In this example, an external system 130 may associate a “listen” action it created with an object having a type of “user” that was generated by the social networking system 140, allowing the “listen” action to be associated with an object representing a user of the social networking system 140 performing a voice-over-IP application phone call between the user of the social networking system 140 and a user of the voice-over-IP application. If the user of the voice-over-IP application is not a user of the social networking system 140, the external system 130 specifies the information describing the action that is received by the social networking system 140 for presentation to social networking system users.

Each user of the social networking system 140 is associated with a user profile, which is stored in the user profile store 152. A user profile includes declarative information about the user that was explicitly shared by the user and may also include profile information inferred by the social networking system 140. In one embodiment, a user profile includes multiple data fields, each describing one or more attributes of the corresponding social networking system user. Examples of information stored in a user profile include biographic, demographic, and other types of descriptive information, such as work experience, educational history, gender, hobbies or preferences, location and the like. A user profile may also store other information provided by the user, for example, images or videos. In certain embodiments, images of users may be tagged with information identifying the social networking system users displayed in an image. A user profile in the user profile store 152 may also maintain references to actions by the corresponding user performed on content items associated with objects in the object manager 142 and stored in the action store 156.

While user profiles in the user profile store 152 are frequently associated with individuals, allowing individuals to interact with each other via the social networking system 140, user profiles may also be stored for entities such as businesses or organizations. This allows an entity to establish a presence on the social networking system 140 for connecting and exchanging content with other social networking system users. The entity may post information about itself, about its products or provide other information to users of the social networking system using a brand page associated with the entity's user profile. Other users of the social networking system may connect to the brand page to receive information posted to the brand page or to receive information from the brand page. A user profile associated with the brand page may include information about the entity itself, providing users with background or informational data about the entity.

The action logger 154 receives communications about user actions internal to and/or external to the social networking system 140, populating the action store 156 with information about user actions. Examples of actions include adding a connection to another user, sending a message to another user, uploading an image, reading a message from another user, viewing content associated with another user, and attending an event posted by another user. In addition, a number of actions may involve an object and one or more particular users, so these actions are associated with those users as well and stored in the action store 156.

The action store 156 may be used by the social networking system 140 to track user actions on the social networking system 140, as well as actions on external systems 130 that communicate information to the social networking system 140. Users may interact with various objects on the social networking system 140, and information describing these interactions is stored in the action store 156. Examples of interactions with objects include: commenting on posts, sharing links, checking-in to physical locations via a mobile device, accessing content items, and any other suitable interactions. Additional examples of interactions with objects on the social networking system 140 that are included in the action store 156 include: commenting on a photo album, communicating with a user, establishing a connection with an object, joining an event, joining a group, creating an event, authorizing an application, using an application, expressing a preference for an object (“liking” the object), and engaging in a transaction. Additionally, the action store 156 may record a user's interactions with advertisements on the social networking system 140 as well as with other applications operating on the social networking system 140. In some embodiments, data from the action store 156 is used to infer interests or preferences of a user, augmenting the interests included in the user's user profile and allowing a more complete understanding of user preferences.

The action store 156 may also store user actions taken on an external system 130, such as an external website, and communicated to the social networking system 140. For example, an e-commerce website may recognize a user of a social networking system 140 through a social plug-in enabling the e-commerce website to identify the user of the social networking system 140. Because users of the social networking system 140 are uniquely identifiable, e-commerce websites, such as in the preceding example, may communicate information about a user's actions outside of the social networking system 140 to the social networking system 140 for association with the user. Hence, the action store 156 may record information about actions users perform on an external system 130, including webpage viewing histories, advertisements that were engaged, purchases made, and other patterns from shopping and buying.

In one embodiment, the edge store 144 stores information describing connections between users and other objects on the social networking system 140 as edges. Some edges may be defined by users, allowing users to specify their relationships with other users. For example, users may generate edges with other users that parallel the users' real-life relationships, such as friends, co-workers, partners, and so forth. Other edges are generated when users interact with objects in the social networking system 140, such as expressing interest in a page on the social networking system 140, sharing a link with other users of the social networking system 140, and commenting on posts made by other users of the social networking system 140.

In one embodiment, an edge may include various features each representing characteristics of interactions between users, interactions between users and objects, or interactions between objects. For example, features included in an edge describe rate of interaction between two users, how recently two users have interacted with each other, the rate or amount of information retrieved by one user about an object, or the number and types of comments posted by a user about an object. The features may also represent information describing a particular object or user. For example, a feature may represent the level of interest that a user has in a particular topic, the rate at which the user logs into the social networking system 140, or information describing demographic information about a user. Each feature may be associated with a source object or user, a target object or user, and a feature value. A feature may be specified as an expression based on values describing the source object or user, the target object or user, or interactions between the source object or user and target object or user; hence, an edge may be represented as one or more feature expressions.

The edge store 144 also stores information about edges, such as affinity scores for objects, interests, and other users. Affinity scores, or “affinities,” may be computed by the social networking system 140 over time to approximate a user's interest in an object or another user in the social networking system 140 based on the actions performed by the user. A user's affinity may be computed by the social networking system 140 over time to approximate a user's interest for an object, interest, or other user in the social networking system 140 based on the actions performed by the user. Computation of affinity is further described in U.S. patent application Ser. No. 12/978,265, filed on Dec. 23, 2010, U.S. patent application Ser. No. 13/690,254, filed on Nov. 30, 2012, U.S. patent application Ser. No. 13/689,969, filed on Nov. 30, 2012, and U.S. patent application Ser. No. 13/690,088, filed on Nov. 30, 2012, each of which is hereby incorporated by reference in its entirety. Multiple interactions between a user and a specific object may be stored as a single edge in the edge store 144, in one embodiment. Alternatively, each interaction between a user and a specific object is stored as a separate edge. In some embodiments, connections between users may be stored in the user profile store 152, or the user profile store 152 may access the edge store 144 to determine connections between users.

Using information in the action store 156 as well as in the object manager 142, the object manager 142 generates content items for presentation to social networking system users. For example, the object manager 142 generates stories describing an action performed by a user and the user that performed the action. The content items may also identify an object on which the action was performed. In one embodiment, a story describing an action performed by a user is presented to additional users connected to the user; for example, a user is presented with a news feed that includes stories describing actions performed by additional users connected to the user. Additionally, the object manager 142 may communicate actions, users, and/or objects associated with actions to an external system 130 when a request for such information is received from the external system 130. The object manager 142 may also access user profiles associated with users that performed an action to determine if the object manger 142 is authorized to send information describing the action to an external system 130. For example, the object manager 142 accesses one or more privacy settings in a user's user profile to determine if information describing actions performed by the user may be communicated to an external system 130.

The interface generator 148 generates one or more interfaces, such as web pages, including content from the social networking system 140. For example, interfaces generated by the interface generator 148 include images, video, profile information, or other data. The interface generator 148 also generates one or more interfaces allowing the social networking system 140 to request information from users and for users to provide information to the social networking system 140 via a client device 110 and the network 120. For example, the interface generator 148 generates a form for a user to provide biographic information, such as the user's age, for inclusion in the user's user profile. When other users request a user's profile page, the interface generator 148 retrieves data from the profile store 152 and generates a representation of the information in the user profile for presentation by a client device 110.

As discussed in greater detail below, the interface generator 148 and the collections manager 150 present information to a social networking system user for creating and managing collections that include various objects. A collection includes a plurality of objects having one or more common characteristics. For example, the interface generator 148 and the collections manager 150 generate one or more collection interfaces allowing a user to provide input to the social networking system 140 for including objects into one or more collections that include various objects. A collection interface may display options for creating a new collection, adding objects maintained by the social networking system 140 to a collection, sharing a collection with other users, or performing any other suitable action.

### Collectable Objects and Collections

The collections manager 150 identifies objects capable of being included in a collection and stores information describing one or more collections. In some embodiments, the collections manager 150 communicates information to the interface generator 148 to configure one or more collection interfaces for presentation to the user. The collections manager 150 determines whether an object is “collectable” based on an object type associated with the object. In one embodiment, information identifying types of objects capable of being included in a collection is stored by the collections manager 150. When an object is to be presented to a user of the social networking system 140, a type associated with the object is determined from the object manager 142 and compared to the types of objects capable of being included in a collection. An object associated with a type that is capable of being included in a collection is a “collectable object.” Types of objects capable of being included in a collection may be identified by administrators of the social networking system 140 and/or administrators of an external system 130 specifying one or more objects to the social networking system 140. In some embodiments, types of objects capable of being included in a collection are determined by the collections manager 150 applying one or more rules to properties of objects included in the object manager 142; types associated with objects satisfying one or more of the rules are identified as types of objects capable of being included in a collection. Additionally, the collections manager 150 associates actions associated with a type of object with one or more collections or categories of collections.

The collections manager 150 communicates with the interface generator 148 to present a collection interface to the user if an object is capable of being included in a collection. For example, the collection interface is presented to the user along with the object. The collection interface allows the user to provide an input to the social networking system 140 to include an object presented to a user along with the collection interface to one or more collections associated with the user. When the user selects a collection presented along with an object, an object identifier associated with the object is associated with a collection identifier associated with the selected collection and stored in the collections manager 150. In one embodiment, the collections manager 150 includes collection identifiers associated with descriptive information associated with various collections. Object identifiers associated with objects included in a collection are stored in the collections manager 150 and associated with the collection identifier associated with the collection. One or more user identifiers are also associated with a collection identifier to indicate users of the social networking system 140 associated with a collection (e.g., a user that created a collection, users capable of adding objects to the collection, etc.). Additionally, one or more actions are associated with a collection identifier to specify actions capable of being performed on types of objects included in the collection.

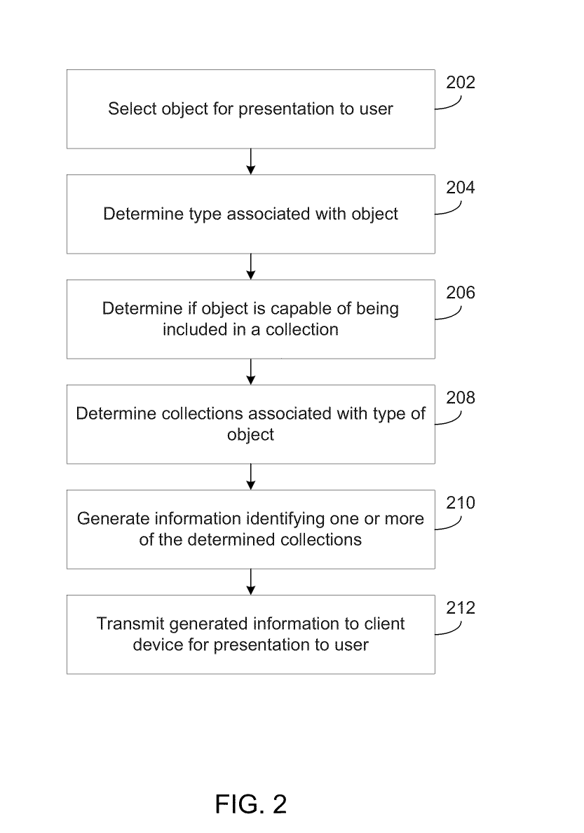

FIG. 2 is a flow chart showing one embodiment of a method for presenting collections associated with an object presented to a social networking system user. In some implementations, the steps are performed in an order other than the order presented in FIG. 2. Different and/or additional steps than those shown in FIG. 2 may be performed in some embodiments.

An object is selected 202 from the objects stored in the object manager 142 for presentation to a user of the social networking system 142. For example, an object associated with a story is selected 202 for inclusion in a news feed presented to the user. Based on information associated with the selected object in the object manager, a type associated with the object is determined 204. For example, an object identifier associated with the selected object is retrieved and a type associated with the object identifier is determined 204 from the object manager 142.

The determined type of the selected object is compared to types of objects identified by the collections manager 150 as capable of being included in a collection to determine 206 if the selected object is capable of being included in a collection. If the determined type of the selected object matches a type of an object capable of being included in a collection, actions associated with the determined type of the selected object are retrieved from the object manager 142. Based on the actions associated with the determined type of the selected object, one or more collections associated with the determined type of the selected object are determined 208. In one embodiment, the actions associated with the determined type of the selected object are used to determine categories of collections associated with the determined type. A category of collection identifies an action or a characteristic associated with a collection. For example, the selected object has a type of “product” that is associated with the actions “own” and “want,” so categories of collections determined 208 to be associated with the selected object are collections associated with an action of “own” or “want.” Alternatively, specific collections associated with the user and different action types are identified based on the actions associated with the determined type of the selected object.

Information identifying the determined collections or determined categories of collections is generated 210 and transmitted 212 to a client device 110 for presentation to the user. For example, a collection interface identifying one or more of the determined collections or categories of collections is generated 210 and transmitted 212 to a client device 110. The collection interface may be displayed to the user along with the selected object, in some embodiments. Information identifying a determined collection may be a name associated with a collection identifier from the collections manager 150, a description of an action associated with a category of collection, images of objects included in a collection associated with the user and with an action, or other suitable information. The information identifying the determined collections or determined collections of categories may be presented by a client device when the user is accessing the social networking system 140 or when the user is accessing an external system 130 via the client device 110.

If a user selects a collection or category of collection identified by the information, the selected object is included in the selected collection or in a collection associated with the selected category of collection. Information in the collections manager 150 is accessed to determine if a collection identifier associated with a selected collection or category of collection is stored. If the collections manager 150 does not include a collection identifier associated with the selected collection or category of collection, a collection identifier and information describing a collection is stored in the collections manager 150 to generate a new collection. An object identifier is then associated with the collection identifier and the association stored in the collections manager 150 to include the selected object in the newly generated collection. However, if the collections manager 150 includes a collection identifier associated with the selected collection or category of collection, the object identifier associated with the selected object is associated with the collection identifier and the association stored in the collections manager 150.

In some embodiments, when an object is added to a collection, the social networking system 140 generates a content item identifying the user adding the object to the collection and the addition of the object to the collection. For example, the object manager 143 generates a story identifying a user adding the object to the collection and also identifying the object and the collection; this story may be presented to additional users connected to the user via the social networking system 140. As an example, the story is presented in a news feed presented to an additional user connected to the user or is presented on user's profile page; however, the story may be presented to users of the social networking system through any suitable communication channel.

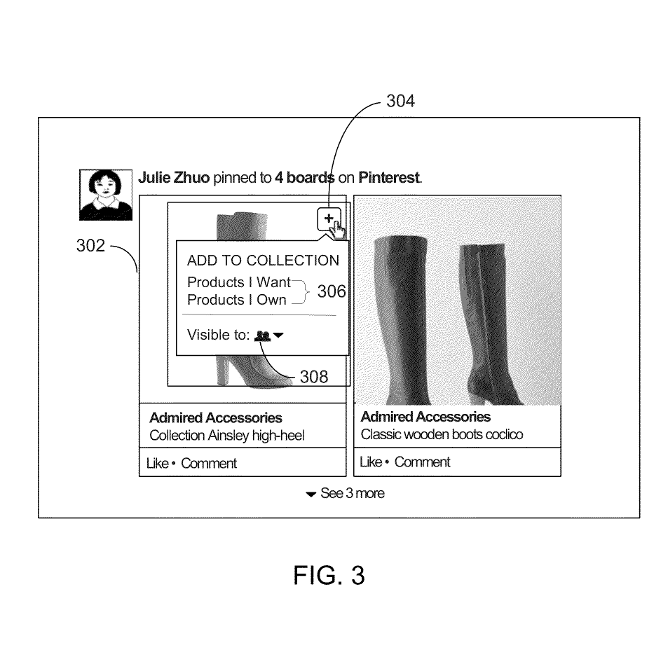

FIG. 3 illustrates an example collection interface 604 presented to a social networking system user. In the example of FIG. 3, an object 302 is presented to a user in a news feed, and is an object capable of being included in a collection. For purposes of illustration, the object 302 has a type of “product,” and the collection interface 604 is displayed in conjunction with the object 302 and enables the user to add the object 302 to one or more collections associated with the user. In the example of FIG. 3, the collection interface 304 includes two categories of collections 306, identified as “Products I own!” and “Products I want!” When the user selects one of the categories of collections 306, an object identifier associated with the object 302 is associated with a collection identifier associated with the selected category of collection. The collection interface 304 may also include a privacy setting option 308 allowing the user to identify additional users of the social networking system capable of accessing the collection or capable of receiving a notification that the object 302 is added to a collection.

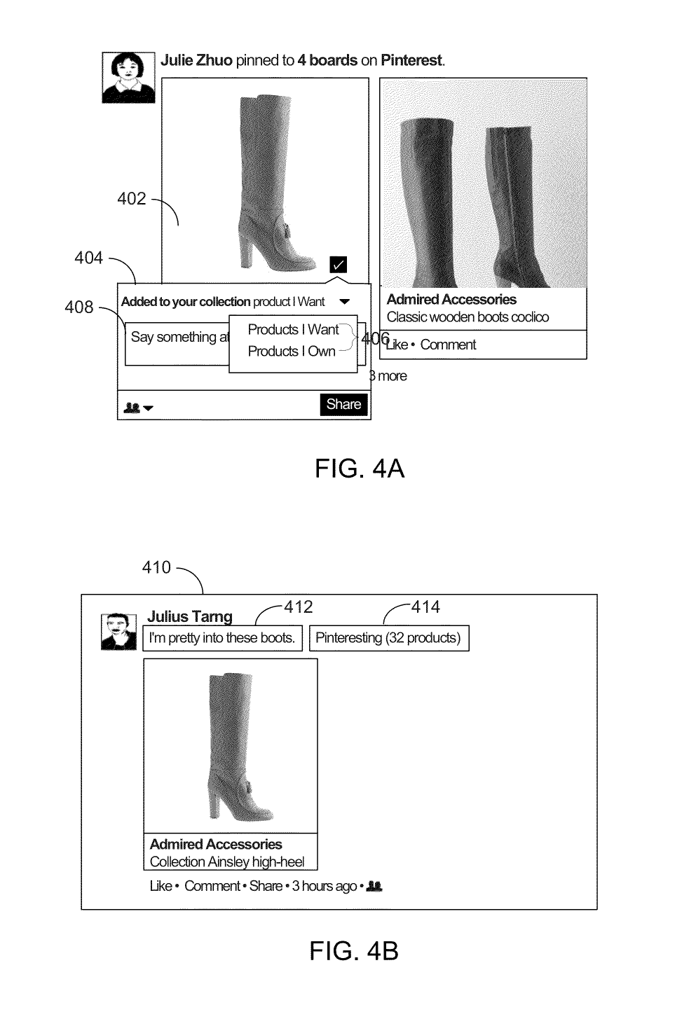

FIG. 4A illustrates an alternative example of a collection interface. In the example of FIG. 4A, an object 402 is presented to a user of the social networking system 140 and is associated with a type of “product.” The collection interface 404 is displayed in conjunction with the object 402 and enables the user to add the object 402 to one or more collections associated with the user. In the example of FIG. 4, the collection interface 304 includes two categories of collections 406, identified as “Products I own!” and “Products I want!” When the user selects one of the categories of collections 406, an object identifier associated with the object 402 is associated with a collection identifier associated with the selected category of collection. The collection interface 404 shown in FIG. 4A also includes a comment entry region 408 allowing the user to provide a comment that is presented in a content item describing the object 402 added to a collection.

FIG. 4B illustrates a story 410 indicating that the object 404 was added to a collection. In the example of FIG. 4B, the story 410 specifies the object 402, identifies the collection 414 to which the object 402 was added, and includes a comment 412 associated with the object by providing information to the comment entry region 408 of the collections interface 404. The story 410 also identifies the user that added the object to the collection. In other embodiments, different and/or additional information may be included in the story 410.

A user may view objects included in a collection. For example, the interface generator 148 presents information identifying objects included in a collection based on information from the object manager 142 and from the collections manager 150. As another example, the interface generator 148 presents information describing collections associated with a user based on information from the collections manager 150. If a user selects a collection from the presented information, objects included in the collection are identified from the collections manager 150 and information describing the objects is retrieved from the object manager 142. If an object is selected from the information, detailed information about the selected object is presented (e.g., price, style information, availability, third party websites where the item may be purchased, product description, or any suitable information). Additionally, one or more privacy settings associated with the user associated with a collection may be retrieved from the user profile store 152 to regulate additional users of the social networking system 140 capable of accessing information describing collections associated with the user.

Additionally, a collection including an object may be changed based on a user interacting with the object. For example, if an object is included in a collection and the user performs an action on the object that is associated with an additional collection, an association between an object identifier associated with the object an a collection identifier associated with the collection is removed and an association between the object identifier and an additional collection identifier associated with the additional collection is stored in the collection manager 150. The action performed on the object may be selected from a group of actions, allowing the social networking system 140 or an external system 130 to specify a group of actions that change the collection including an object when performed. In one embodiment, the user is prompted to confirm the change in association between the object identifier from the collection identifier to the additional collection identifier. Alternatively, the association of the object identifier is changed from collection identifier to additional collection identifier when the action is performed.

In some embodiments, an object is included in a collection when a user performs an action on the object. For example, the social networking system 140 or an external system 130 identifies one or more actions associated with a type of object that include an object having the type into a collection associated with the user and an identified action when performed by the user. Thus, after determining a type associated with an object presented to a user, the social networking system 140 identifies actions associated with the type that include one or more actions that include the object in a collection when performed on the object. For example, an object having a type of “product” is added to a collection associated with an action “like” when the social networking system 140 receives an action from the user indicating a preference for the object. In these embodiments, the collection to which an object is added is based on the type of the object and an action associated with the type that is performed by the user. Thus, rather than identify a collection in which an object is included from information identifying collections associated with an action, the social networking system 140 may include an object having a type when a user performs one or more actions associated with the type.

### Summary

The foregoing description of the embodiments of the invention has been presented for the purpose of illustration; it is not intended to be exhaustive or to limit the invention to the precise forms disclosed. Persons skilled in the relevant art can appreciate that many modifications and variations are possible in light of the above disclosure.

Some portions of this description describe the embodiments of the invention in terms of algorithms and symbolic representations of operations on information. These algorithmic descriptions and representations are commonly used by those skilled in the data processing arts to convey the substance of their work effectively to others skilled in the art. These operations, while described functionally, computationally, or logically, are understood to be implemented by computer programs or equivalent electrical circuits, microcode, or the like. Furthermore, it has also proven convenient at times, to refer to these arrangements of operations as modules, without loss of generality. The described operations and their associated modules may be embodied in software, firmware, hardware, or any combinations thereof.

Any of the steps, operations, or processes described herein may be performed or implemented with one or more hardware or software modules, alone or in combination with other devices. In one embodiment, a software module is implemented with a computer program product comprising a computer-readable medium containing computer program code, which can be executed by a computer processor for performing any or all of the steps, operations, or processes described.

Embodiments of the invention may also relate to an apparatus for performing the operations herein. This apparatus may be specially constructed for the required purposes, and/or it may comprise a general-purpose computing device selectively activated or reconfigured by a computer program stored in the computer. Such a computer program may be stored in a non-transitory, tangible computer readable storage medium, or any type of media suitable for storing electronic instructions, which may be coupled to a computer system bus. Furthermore, any computing systems referred to in the specification may include a single processor or may be architectures employing multiple processor designs for increased computing capability.

Embodiments of the invention may also relate to a product that is produced by a computing process described herein. Such a product may comprise information resulting from a computing process, where the information is stored on a non-transitory, tangible computer readable storage medium and may include any embodiment of a computer program product or other data combination described herein.

Finally, the language used in the specification has been principally selected for readability and instructional purposes, and it may not have been selected to delineate or circumscribe the inventive subject matter. It is therefore intended that the scope of the invention be limited not by this detailed description, but rather by any claims that issue on an application based hereon. Accordingly, the disclosure of the embodiments of the invention is intended to be illustrative, but not limiting, of the scope of the invention, which is set forth in the following claims.

What is claimed is:

1. A method comprising:
storing one or more objects in a social networking system, each object associated with a type, the type associated with one or more actions capable of being performed on objects associated with the type;
selecting an object from the stored one or more objects for presentation to a user of the social networking system;
determining that the object is capable of being included in one or more collections based on the type associated with the object;
identifying one or more collections associated with the type associated with the object based at least in part on the one or more actions associated with the type, each collection associated with an action associated with the type;
generating information describing the one or more collections associated with the type associated with the object; and
transmitting the generated information describing the one or more collections to a client device for presentation to the user of the social networking system.

2. The method of claim 1, wherein transmitting the generated information describing the one or more collections to the client device for presentation to the user of the social networking system comprises:
transmitting the object and the generated information describing the one or more collections for presentation in conjunction with the object.

3. The method of claim 1, further comprising:
receiving a selection of a collection described by the generated information; and
associating an object identifier associated with the object with a collection identifier associated with the selected collection; and
storing the association between the object identifier associated with the object and the collection identifier associated with the selected collection in the social networking system.

4. The method of claim 3, wherein associating the object identifier associated with the object with the collection identifier associated with the selected collection comprises:
generating the collection identifier associated with the selected collection if the collection identifier is not included in the social networking system; and
associating an object identifier associated with the object with the collection identifier associated with the selected collection.

5. The method of claim 3, further comprising:
receiving an action associated with the object, the action associated with an additional collection different than the selected collection; and
associating the object identifier associated with the object with an additional collection identifier associated with the additional collection;

6. The method of claim 5, further comprising:
removing the association between the object identifier and the collection identifier associated with the selected collection.

7. The method of claim 5, wherein the received action is selected from a group of actions.

8. The method of claim 3, further comprising:
generating a story identifying the user, the object and the selected collection.

9. The method of claim 8, further comprising:
communicating the story to one or more client devices associated with additional users of the social networking system connected to the user.

10. The method of claim 1, wherein the object is associated with one or more properties received from an external system.

11. The method of claim 1, wherein an action capable of being performed on objects associated with the type is based at least in part on one or more properties received from an external system.

12. A computer program product comprising a computer-readable storage medium having instructions encoded thereon that, when executed by the processor, cause the processor to:
store one or more objects in a social networking system, each object associated with a type, the type associated with one or more actions capable of being performed on objects associated with the type;
select an object from the stored one or more objects for presentation to a user of the social networking system;
determine that the object is capable of being included in one or more collections based on the type associated with the object;
identify one or more collections associated with the type associated with the object based at least in part on the one or more actions associated with the type, each collection associated with an action associated with the type;
generate information describing the one or more collections associated with the type associated with the object; and
transmit the generated information describing the one or more collections to a client device for presentation to the user of the social networking system.

13. The computer program product of claim 12, wherein transmit the generated information describing the one or more collections to the client device for presentation to the user of the social networking system comprises:
transmit the object and the generated information describing the one or more collections for presentation in conjunction with the object.

14. The computer program product of claim 12, wherein the computer readable storage medium further has instructions encoded thereon that, when executed by the processor, cause the processor to:
receive a selection of a collection described by the generated information; and
associate an object identifier associated with the object with a collection identifier associated with the selected collection; and
store the association between the object identifier associated with the object and the collection identifier associated with the selected collection in the social networking system.

15. The computer program product of claim 14, wherein associate the object identifier associated with the object with the collection identifier associated with the selected collection comprises:
generate the collection identifier associated with the selected collection if the collection identifier is not included in the social networking system; and
associate an object identifier associated with the object with the collection identifier associated with the selected collection.

16. The computer program product of claim 14, wherein the computer readable storage medium further has instructions encoded thereon that, when executed by the processor, cause the processor to:
receive an action associated with the object, the action associated with an additional collection different than the selected collection; and
associate the object identifier associated with the object with an additional collection identifier associated with the additional collection.

17. The computer program product of claim 16, wherein the received action is selected from a group of actions.

18. The computer program product of claim 14, wherein the computer readable storage medium further has instructions encoded thereon that, when executed by the processor, cause the processor to:
generate a story identifying the user, the object and the selected collection.

19. The computer program product of claim 18, wherein the computer readable storage medium further has instructions encoded thereon that, when executed by the processor, cause the processor to:
communicate the story to one or more client devices associated with additional users of the social networking system connected to the user.

20. The computer program product of claim 12, wherein the object is associated with one or more properties received from an external system.

21. The computer program product of claim 12, wherein an action capable of being performed on objects associated with the type is based at least in part on one or more properties received from an external system.
